SEQUENCE LISTING (1 sequence)

SEQ ID NO: 1 - protein, 4 aa, Artificial
  The three amino acid sequence RGD which occurs on Fibronectine cell adhesion protein is modified with cystine to provide RGDC
RGDC

(19) United States
(12) Patent Application Publication
(10) Pub. No.: US 2004/0265571 A1
(43) Pub. Date: Dec. 30, 2004

(54) Surface-bonded, organic acid-based mono-layers

(75) Inventors: Jeffrey Schwartz, Princeton, NJ (US); Eric L. Hanson, Princeton, NJ (US); Michael D. Carolus, Princeton, NJ (US); Michael P. Danahy, Princeton, NJ (US); Jean E. Schwarzbauer, Princeton, NJ (US); Kim S. Midwood, Princeton, NJ (US)

Correspondence Address: SYNNESTVEDT & LECHNER, LLP, 2600 ARAMARK TOWER, 1101 MARKET STREET, PHILADELPHIA, PA, 191072950

(73) Assignee: Princeton University, Princeton, NJ (US)

(21) Appl. No.: 10/701,591

(22) Filed: Nov. 4, 2003

Related U.S. Application Data
(60) Provisional application No. 60/490,613, filed on Jul. 28, 2003.
(60) Provisional application No. 60/467,348, filed on May 2, 2003.
(60) Provisional application No. 60/446,681, filed on Feb. 11, 2003.
(60) Provisional application No. 60/446,680, filed on Feb. 11, 2003.

(51) Int. Cl. B05D 5/00; B32B 15/04

(52) U.S. Cl. 428/333; 427/372.2

(57) ABSTRACT

The present invention provides a process for providing on the surface of a substrate a chemically bonded, densely-packed, oriented organic acid-based mono-layer, the method comprising: (i) providing on at least a portion of said surface of said substrate a densely-packed, adsorbed oriented mono-layer comprising a plurality of at least one organic acid species wherein each of the organic acid species comprising said adsorbed mono-layer has at least one acid functional group associated with said surface of said substrate; and (ii) bonding to the surface of said substrate said surface-associated acid functional groups.

### CROSS-REFERENCE TO RELATED APPLICATIONS

The present application is based on and claims the priority of U.S. provisional application Nos. 60/490,613, filed Jul. 28, 2003, 60/467,348, filed May 2, 2003, and 60/446,681 and 60/446,680, both of which were filed Feb. 11, 2003, all of which are incorporated herein by reference.

### BACKGROUND

The provision of an organic layer which is bonded to the surface of a substrate having insulating, metallic, conductive, or electronic properties is essential in building up devices for use as an interface between inorganic materials and organic or biological materials. Examples of interfaces using a biological/inorganic material interface are materials for in vivo implant, for example, bone ingrowth-promoting orthopedic implants and implantable biosensors that utilize a bioactive layer to detect a chemical or biological species. In such biosensor devices, a biologically active layer (also referred to herein as an bioactive layer) is coupled to a semi-conductor layer to generate an electronic or optical signal proportional to the amount or concentration of the species detected. Devices utilizing an organic/inorganic material interface are, for example, organic-based transistors (OT's) and light emitting diodes (OLED's).

The mechanical, chemical, and electronic properties of the interface between an organic or bioactive layer and an inorganic substrate depend upon many factors, not the least of which are: (a) the organization of the molecular moieties comprising the layer, for example, their alignment and attachment to the substrate's surface; and (b) the area specific density of bonds between the surface of the substrate and the organic layer. Additionally, the interface must display chemically stability and be robust under the conditions of use or it will deteriorate in use.

In general, increasing the area-specific density of bonds between a layer deposited on the surface of a substrate and the substrate increases the stability of the attachment of the layer. Additionally, increasing the number of bonds between the layer and the surface within a given surface area can increase also the charge carrier flux through the layer into or away from the surface.

It is well known to develop an organic layer covering a substrate surface using polymerization methods to deposit a polymer layer on the surface. In general these layers do not display good surface conformation. That is, the growth of polymer overlayers tends to occur by surface attachment of monomer moieties at isolated locations across the surface (“islands”) which are incorporated into a polymer as polymerization proceeds from these islands outward until the polymeric mass eventually bridges over the surface between “islands”, but without forming additional chemical bonds to the surface. This growth and bonding pattern tends to form layers which have a thickness equal to many layers of the species comprising the layer (often hundreds of nanometers to microns thick) but which have relatively few bonds between the species comprising the coating layer and the substrate surface. Organic layers comprising bulk polymers, applied for example, by “spin-on” techniques are also well known. These types of coatings also display the same type of sparse bonding pattern between the substrate surface and the coating. Coated substrates having a low number of bonds per unit area of surface between the coating and substrate surface exhibit poor mechanical attachment between the substrate and the coating and poor electronic communication between the substrate surface and the coating. As a consequence they are not mechanically robust and do not in general display long term stability. Such coatings also may not display efficient charge carrying properties when used in electronic devices.

In part, the prior art surface-bonded organic layers have low numbers of bonds per unit surface area because the layers are bonded to the substrate utilizing the functional groups which are found on the native surface. In general, groups sufficiently reactive to utilize in bonding additional species to the surface occur sparsely across the surface. An example of this are silanol functional groups which are frequently employed in derivatizing reactions carried out on the native oxide surface of silicon, for example, by silanizing the surface with for example, organo-chlorosilanes to form carbosiloxane species bonded to the surface. Generally, the organic portion of the derivatizing silane contains also some functional group which is stable to the silanization reaction that can be incorporated by application of conventional organic chemistry into a polymeric structure, for example, epoxides and sites of unsaturation, for example, a carbon-carbon double bond. Alternatively, the surface can be derivatized by reducing reactive surface sites to yield a silane or chlorosilane species on the surface of the silicon substrate and carrying out conventional organo-silane chemistry to form surface-bonded organosilane species. An example of this is hydrosilylation of an unsaturated organic moiety using a surface bound silicon hydride functional groups prepared in such a surface derivatizing reaction.

These surface derivitizing methods extensively modify the starting surface and require strict environmental control because they render the surface of the substrate moisture and oxygen sensitive at the intermediate silane or chlorosilane stage during surface preparation.

As described above, surface derivatizing reactions relying upon conversion of native-occurring reactive surface sites to provide a layer bonded to the surface yields coatings which are poorly organized regions of material that are multiple-molecular layers thick, and adjacent thereto, “void” areas where the derivatizing species is not bonded to the surface of the substrate. Utilizing the above-described methods to provide an organic layer that completely covers the surface, either by incorporation of “islands” of bound surface species or application of a bulk polymer yields a surface layer that is poorly organized, not robustly adhered to the surface and provides poor electronic interaction with the substrate.

For electronic application, for example sensors, this can hinder efficient charge carrier transport through the organic layer to the substrate. For materials applications which rely on the surface bound layer for adhesion and mechanical strength, for example, in medical implants which promote bone ingrowth, the discontinuous nature of the bonding of the surface layer to the substrate provides an interface of insubstantial mechanical strength which can be prone to separation from the substrate.

What is needed is an organized, organic layer bonded to the oxide surface of a substrate with a high surface-area specific number of bonds between the layer and the substrate surface regardless of the paucity of reactive functional groups present on the native surface. Also needed is a general method for providing such a layer on a variety of surfaces, whether single crystal, polycrystalline, or amorphous.

### SUMMARY OF THE INVENTION

The inventors have surprisingly found that these needs can be met by bonding to the oxide surface of a substrate a dense, oriented mono-layer comprising an adsorbed organic acid.

The present invention provides a process for providing on at least a portion of the surface of a substrate a dense, oriented organic mono-layer, the process comprising:

a. providing a substrate surface comprising a plurality of hydrolyzable functional groups;

b. adsorbing onto at least a portion of said substrate surface at least one organic acid species, characterized in that it has at least one acid functional group, in a quantity sufficient to form a dense, oriented mono-layer comprising, at the interface comprising the adsorbed organic acid species and the surface of said substrate, at least some of said acid functional groups in bond-making proximity to said substrate surface hydrolyzable functional groups; and

c. bonding at least a portion of said acid functional groups at said interface with said surface hydrolyzable functional groups of said substrate.

It is preferred to repeat the process of the invention until the mono-layer provided by the process covers, substantially without void areas, the entirety of the selected portion of oxide surface to be provided with a mono-layer.

It is preferred to carry out the “bonding step” (step c) of the process by supplying to the interfacial region comprising the adsorbed mono-layer and the oxide surface of the substrate a sufficient amount of heat energy for a sufficiently long period of time to cause at least some of the acid functional groups in the interfacial region comprising the adsorbed mono-layer and the surface functional groups to form a chemical bond. It is more preferred to bond the adsorbed mono-layer by heating the adsorbed mono-layer and substrate to a temperature of at least about 100° C.

It is preferred to carry out the adsorption step (b) by supplying the organic acid species to the substrate surface by a means that provides the organic acid species to the surface in a form that has no enforced long-range order. The preferred form of the organic acid species is a solution comprising the organic acid species and a solvent wherein the organic acid species is present in a concentration which is less than about the critical micelle concentration for the solution.

When an absorbed mono-layer is provided from a solution of the acid, the preferred method of forming an absorbed, dense, oriented mono-layer on at least a portion of said substrate surface is to contact the substrate surface with a quantity of a solution containing at least one organic acid species in an amount sufficient to form a dense oriented mono-layer. More preferably, the solution is contacted to the substrate surface by immersing the substrate surface in a volume of the solution.

Preferably, after the solution has been contacted to the substrate surface, the remaining solution is removed from contact with said substrate under conditions which leave on at least a portion of said substrate surface said adsorbed, dense, oriented mono-layer film. Preferably, this is accomplished by evaporating solvent from said solution under conditions sufficient to form a densely-packed oriented mono-layer until the volume of solution in which the substrate was immersed is insufficient to cover the substrate. It is preferred for the mono-layer to comprise at the interface comprising the adsorbed organic acid species and the surface of said substrate, at least one of the acid functional groups of a substantial number of said organic acid species in bond-making proximity to said substrate surface hydrolyzable functional groups.

Preferred substrate surfaces are the oxide surfaces of substrates selected from the group consisting of a bulk oxide substrate, a metal substrate, and a semiconductor substrate. More preferred is the native oxide surface of an electronic material substrate selected from the group consisting of a metal, a semiconductor, and an oxide conductor and a thick oxide insulator layer, for example, a high dielectric glass. Especially preferred are substrates are GaAs, silicon, InP, GaN, tin oxide doped to conduction with indium and/or zinc, zinc oxide doped to conduction with aluminium, zinc oxide, doped oxides based on, for example, TiO, FeO, and VO.

For some applications it is preferred for the organic acid species to be selected from the group consisting of mono-, di-, and polyfunctional sulfonic acids. For most applications it is preferred for the organic acid species to be selected from the group consisting of mono-, di- and polyfunctional carboxylic acids, and mono-, di- and polyfunctional phosphonic acids. It is more preferred for the organic acid species to comprise an organic portion selected from the group consisting of a substituted or unsubstituted thiophene moiety, a substituted or unsubstituted polythiophene moiety, and a substituted or unsubstituted hydrocarbon moiety having from about 2 to about 40 carbon atoms, said hydrocarbon moiety further characterized in that it is a linear or branched, saturated or unsaturated, substituted or unsubstituted aliphatic or aromatic moiety which is optionally substituted with additional functional groups selected from the group consisting of hydroxyl, amino, carboxylate, phosphonate, and thiol functional groups.

The present invention provides also a densely-packed, oriented, organic acid-based mono-layer prepared by the method of the invention.

These and other aspects and advantages of the present invention will be obvious from the following detailed description and examples.

### DETAILED DESCRIPTION OF THE INVENTION

The inventors have surprisingly found that a robust, surface conforming, dense, oriented, organic mono-layer can be provided which is bonded to the hydrolyzable surface of a crystalline, polycrystalline, or amorphous substrate by at least one functional group of substantially each of the moieties comprising the mono-layer. The inventors have also surprisingly found a process for providing a mono-layer covering the surface of a substrated over a selected region of the substrate which is substantially without void areas and substantially devoid of areas having multi-layer coverage. The dense, oriented organic mono-layers provided by the present invention are unique in their extent of coverage of the surface without void areas, high degree of orientation of the individual moieties comprising the layer, and low-dimensionality of the layer over a large substrate area (that is, to a substantial degree the layer is only a single molecule thick).

As used herein, the term “dense mono-layer” describes a film comprising a plurality of one or more moieties either bonded to or adsorbed onto at least a portion of a substrate surface that to a substantial extent template on the surface (that is, adsorbs in an orientation that repeats with respect to a repeating surface feature characteristic of the particular substrate surface to which the coating is being applied, whether the substrate possesses a crystalline, polycrystalline, or amorphous surface) to provide a two dimensional, close-packed, arrangement of the individual moieties from which the mono-layer derives. The dense mono-layer is further characterized by being substantially free of poly-layer formation. As it is used herein, the term “oriented mono-layer” describes a dense mono-layer bonded to or adsorbed onto a substrate surface in which substantially all of the functional group substituents on the molecular species from which the mono-layer was formed reside in the same relative relationship with the surface and the adjacent moieties comprising the mono-layer.

The inventive process provides an organic layer bonded to the hydrolyzable surface of a substrate which has good mechanical and electrical properties and is resistant to removal by solvolysis or sonication.

The inventive process comprises: (i) adsorbing a dense, oriented, organic mono-layer comprising a plurality of at least one organic acid species onto the hydrolyzable surface of the substrate such that at least one acid functional group of the organic acid moiety is associated with the surface, preferably within bonding proximity, and the organic acid species is disposed on the surface in a two-dimensional ordered packing of high density; and (ii) bonding the surface-associated acid functional groups of the organic acid moiety to the surface. The bonded mono-layer is further characterized in that bilayer or multi-layer structures are not formed to any great extent on the surface.

The inventors have also found, surprisingly, that a dense, oriented mono-layer of adsorbed organic acid moieties can be formed on the hydrolyzable surface of a substrate using an organic acid in a form which has no enforced long range order, sometimes referred to herein for convenience as a “disordered form” of the acid. Without wanting to be bound by theory, it is believed that at the contact interface between the acid source and the surface of the substrate, in adsorbing to the substrate surface the acid self-organizes into an oriented mono-layer film under the conditions utilized in providing the adsorbed mono-layer in accordance with the present invention process. The inventors have also surprisingly found that a dense, oriented mono-layer of the organic acid which extends over a large area of a hydrolyzable surface essentially without void areas in the coverage can be provided by repeating the steps of the above-described process until a mono-layer which is essentially void free over the area of the surface of the substrate selected for mono-layer coverage has been formed.

The inventors have found that the process presented herein does not result in the formation of a coating comprising poly-layers derived from the acid species (coating species) from which a coating of the invention is formed. Without wanting to be bound by theory, it is believed that coating species used to form the dense, oriented adsorbed mono-layer “activates” the substrate surface adjacent to its adsorption site during the bonding step which follows adsorption. Without wanting to be bound by theory, it is also believed that this “activation” leads to preferential adsorption of the coating species on the surface adjacent to portions of the surface bearing the bonded mono-layer coating during subsequent treatment cycles, which in turn provides for mono-layer coverage over a broad area of the substrate rather than poly-layer formation as is seen in other coating methods.

As described herein, and without wanting to be bound by theory, it is believed that the coating process of the present invention is applicable to all hydrolyzable surfaces, and in particular, to surfaces comprising an oxide, to provide a coating of the invention thereon. Although the invention is described and illustrated below with surfaces comprising an oxide, it will be appreciated also that these same principles can be applied to surfaces comprising species other than oxides which are subject to activation by a proton transfer process similar to that described below. Thus, for example, it is known that a naked silicon nitride surface will hydrolyze upon exposure to the ambient environment to form a protective oxide coating. This oxide coating provides a hydrolyzable surface upon which a coating of the invention derived from an organic acid maybe applied in accordance with the principles described herein. It will be appreciated also that the naked silicon nitride surface, before being hydrolyzed by ambient moisture, provides also a hydrolyzable surface upon which a coating of the invention can be applied in accordance with these same principles, if the surface is protected from moisture during the coating process such that it is not first hydrolyzed to an oxide surface. It will be appreciated that other non-oxide surfaces which can undergo hydrolysis by the acid species from which a coating is derived may as well be provided with a mono-layer coating comprising an organic acid moiety in accordance with the principles of the present invention described herein.

Described below is a process for preparing a dense mono-layer bonded to the oxide surface of a substrate, organic acids suitable for use in the provision of a mono-layer of the invention, and substrates which have or can be made to have an oxide surface suitable for use in the preparation of substrates having a dense, oriented, surface-bound organic acid-based mono-layer of the invention.

As the term is used herein with respect to an absorbed layer, a dense, oriented mono-layer comprises an arrangement of the individual acid species comprising the mono-layer such that the arrangement approximates a close-packed 2 dimensional “crystal-like” array of the adsorbed species on the surface.

Mono-layers having this type of packing have been observed on very well ordered surfaces having low defect occurrences, for example, octadecylphosphonate adsorbed to mica substrates, as described by Neves et al. in Langmuir 2001, 17, pp 8193-8198, which is incorporated herein in its entirety by reference. Neves et al. observed that contacting a mica surface with solutions of a low concentration of an organic acid (octadecylphosphonic acid) results in the adsorption of the acid species onto the surface in the form of well organized mono-layer regions of the acid, albeit with sparse coverage of the surface, that is, the surface contains “islands” of mono-layer coverage interspersed with large “voids” in surface coverage. Neves et al. did not identify conditions wherein contact of a mica surface with a dilute solution of an organic acid provided a mono-layer film covering substantially all of a macroscopic area of the surface. Neves et al. also observed that contacting a solution sufficiently high in concentration of octadecylphosphonic acid to a mica surface deposits initially domains comprising multi-layers of the phosphonic acid in regions widely dispersed (“islands”) on the surface of the mica. After removing the excess solution from the surface of the mica substrate (a highly ordered, low defect surface with strong adsorption potential for the particular acid studied), Neves et al. observed over time that for sparsely covered surfaces, the multilayers redistribute over time to form dense mono-layer regions having a two dimensional, crystal-like structure, albeit interspersed with void areas having no coverage. Neves et al. did not observe that these mono-layer regions could be expanded to cover the entire surface substantially free of voids without concomitantly building up multilayers in some areas of the surface. Neves et al. also observed that this method when applied to other substrates provided only the formation of multi-layer islands. Thus, glass, silicon or gallium arsenide native oxide surfaces yielded only disorganized, multilayered absorbed films.

Two dimensional arrays of molecular species are seen also in a classically formed Langmuir-Blodgett mono-layers, for example, those described by K. Blodgett in the Journal of the American Chemical Society, 1935 (vol. 57) pp. 1007 to 1022 which require the application of a two dimensional force sufficient to form an aligned layer at one liquid species atop a denser immiscible second liquid species forming organized films of single molecule dimension on the surface of the denser liquid.

As described above, without utilizing an enforced, long-range organization, for example, as is provided in the formation of Langmuir-Blodgett films, prior art processes for the provision of an organized mono-layer on a substrate surface are limited to highly ordered, low defect surfaces and sparse coverage of the mono-layer species.

The inventors have found that a dense, oriented, organic mono-layer comprising an organic acid moiety, for example, a phosphonate acid moiety, which covers a macroscopic area of a substrate surface substantially without void areas can be formed by repeating the process comprising: (i) forming on at least a portion of the surface of a substrate an adsorbed dense, oriented mono-layer comprising the organic acid; and (ii) bonding the species comprising the mono-layer to the surface of the substrate, until there is formed a mono-layer bonded to the surface which covers the desired area of the substrate essentially free of voids.

The Process

The present invention provides a mono-layer coating bonded to the surface of a substrate comprising a moiety derived from at least one organic acid species comprising: (a) providing a substrate having a surface comprising a plethora of hydrolyzable functional groups; (b) adsorbing to the substrate surface a dense, oriented, mono-layer film comprising a plurality of at least one organic acid species, the film being further characterized in that it is oriented such that at least one acid functional group of a substantial number of each member of the organic acid species comprising the mono-layer is associated with the hydrolyzable functional groups of the surface of the substrate; and (c) supplying the conditions necessary to cause a substantial portion of the surface-associated acid functional groups of the organic acid moieties comprising the adsorbed mono-layer to bond to the hydrolyzable functional groups comprising the surface of the substrate. Further, the process of the present invention can be repeated until substantially the entire selected portion of the substrate is covered with a mono-layer bonded thereto, with substantially no area of the substrate covered with a poly layer and substantially no area of the substrate devoid of mono-layer coverage. It will be appreciated that, even though for most applications, successive cycles of the process will be carried out in rapid succession, successive coating operations can be carried out remote in time and/or location and remain within the scope of the present invention. It will be appreciated also that the various process steps described above can be performed essentially contemporaneously, or remote in time and location or remote in time at one location and remain within the scope of the present invention.

While the process of the present invention is described below and exemplified using a substrate surface comprising hydrolyzable functional groups which comprise an oxide, and preferably the hydrolyzable functional groups of the substrate surface are oxide functional groups, it will be appreciated that the process can be carried out on a substrate surface comprising other hydrolyzable functional groups and remain within the scope of the invention.

Providing a Dense, Oriented Adsorbed Mono-Layer

An essential step in providing a dense, oriented mono-layer bonded to the surface of a substrate is the provision, on at least a portion of the substrate surface, of an absorbed mono-layer of the organic acid species from which the bonded mono-layer is formed. The adsorbed mono-layer is further characterized in that is has a dense, oriented arrangement of the organic acid species. Preferably, the organic acid species has an acid functional group associated with the substrate surface. It will be appreciated that any means can be employed to provide an adsorbed dense, oriented mono-layer of the organic acid, as those terms have been defined above (also referred to herein sometimes for convenience as a “dense mono-layer”).

Preferred methods, from the standpoint of convenience and scalability, for forming the adsorbed mono-layer comprise: (i) contacting the surface of the portion of the substrate to be coated with a dilute solution of the organic acid species from which the adsorbed mono-layer is formed; (ii) following step (i), removing from contact with the substrate surface the solution remaining in contact with the substrate surface under conditions which leave a dense, oriented, organic mono-layer on at least a portion of the substrate surface; and (iii) after removing the remaining solution, optionally, contemporaneous with removal of the remaining solution, removing from the monolayer substantially all of the solvent associated with the adsorbed organic acid mono-layer.

One method for carrying out step (i) of this deposition procedure is to inundate the surface with a solution of the acid having a low concentration of the acid as described below. One method of inundating the surface is by immersing the substrate, or the portion of its surface upon which a mono-layer is to be deposited, into a bulk solution of the acid (dip-coating). Another method for inundating the surface is to dispense an aliquot of the acid solution onto the surface in an amount which exceeds that nominally required to wet the surface or portion of the substrate surface to which a mono-layer is to be adsorbed (drop-coating). It will be appreciated that other methods, for example, spraying, fogging, spin coating and the like, may also be used in inundating the surface of the substrate with the acid solution.

Typically, immediately after contacting the substrate surface with a solution of the organic acid, a process of removing the remainder of the solution contacted to the surface from contact with the surface under conditions which leave a dense, oriented, adsorbed mono-layer of the organic acid is begun. It is important to remove the solution from contact with the surface under conditions which leave a dense, oriented, mono-layer of the acid species adsorbed onto at least a portion of the surface, as is explained in detail below.

Step (i) of a “dip-coating” process may conveniently be carried out by suspending the substrate below the surface of a volume of the acid solution (bulk solution) with the surface of the substrate to which an adsorbed mono-layer of the acid species is to be applied oriented essentially perpendicular to a plane which includes the surface of the bulk solution (meniscus plane). Step (ii) of a “dip-coating” process (removing the remaining solution from contact with the substrate under conditions which leave a dense, oriented, organic mono-layer on at least some portion of the substrate surface) can then be conveniently carried out by permitting the solvent of the bulk solution to evaporate such that the meniscus of the surface of the evaporating bulk solution traverses the surface of the substrate in the area to which an adsorbed mono-layer is to be applied.

It is generally preferred to carry out evaporation over a period less than 24 hours, preferably less than about 4 hours, after suspending the substrate in the bulk solution. However, depending upon the concentration of the organic acid in the solution and the affinity of the acid for the surface of the substrate to be coated, longer or shorter times may also be employed. It is also preferred, when using this method of coating, to employ low concentrations of the acid in the bulk solution, as explained in detail below. Especially preferred are concentrations of acid which are sufficiently below the critical micelle concentration or the saturation concentration (which are discussed below) for the particular acid and solvent utilized that after evaporation of the bulk solvent during application of the adsorbed monolayer, the acid in the remaining solution is also at a concentration which is less than the critical micelle concentration or saturation concentration for the acid.

Step (i) of a drop-coating process, inundating the surface with an acid solution, may conveniently be carried out by orienting a substrate surface to which a coating is to be applied horizontally and dispensing onto the surface a measured quantity of an acid solution such that the solution “pools” on that portion of the surface upon which a mono-layer of the acid is to be adsorbed. When a drop-coating process is utilized, step (ii) of the process (removing the remaining solution from contact with the substrate under conditions which leave a dense, oriented, organic mono-layer on at least some portion of the substrate surface) maybe conveniently accomplished by directing a stream of gas, for example nitrogen, across the surface of the substrate in the area to which a mono-layer of the organic acid is to be adsorbed, applying the gas stream to the surface in a manner such that the gas stream causes a gas/solution interface to traverse the surface as it progressively sweeps the residual solution from the surface.

It will be appreciated that using either of these two methods for removing the excess coating solution from contact with the substrate surface accomplishes also step (iii), evaporation of substantially all of the solvent associated with the adsorbed mono-layer at a time that is essentially contemporaneous with the removal of the excess solution from contact with the surface of the substrate. It will be appreciated that other methods, for example, a spin-coating process comprising: (i) flooding the surface with an excess of the organic acid solution; (ii) removing the excess solution from contact with the surface by mechanically throwing off the excess solution by increasing the spinning rate of the substrate; and (iii) driving off the solvent with a gas stream directed at the spinning surface may also be employed to apply an adsorbed dense, oriented, mono-layer of the organic acid species. Other methods will be apparent to those skilled in the coating arts.

The inventors have observed that simple dip coating in bulk solution without removing the excess solution remaining on the surface in accordance with the principles described herein, or drop coating with subsequent simple evaporation of the “pool” of solution from the substrate surface in general does not result in the formation of dense, oriented, adsorbed organic acid mono-layers on a substrate surface. Accordingly, attempts to provide an organic layer bonded to the surface of a substrate by providing an adsorbed acid layer using an acid solution without removing the solution from contact with the surface in accordance with the principles described below results only in the provision of a disordered, organic multi-layer.

One feature common to the methods described above for removing the remaining acid solution from contact with the surface is that they employ some method of traversing the portion of the substrate surface to be provided with an adsorbed mono-layer of the acid with an interface which comprises the substrate surface and the surface of the acid solution from which the adsorbed mono-layer of acid is deposited. While not wanting to be bound by theory, it is believed that when a solution of the acid is contacted to a surface in accordance with the principles described above, at the point of contact between the substrate surface and the acid solution surface there is formed an interface. An example of this interface, as described above, is the point of contact between a substrate surface and the surface of a bulk solution as it evaporates. Another example of this interface is the point of contact at the edge of a “pool” of solution residing on a horizontally disposed substrate surface. Additionally, and again not wanting to be bound by theory, it is believed at the interface between the surface of the solution and the substrate surface the acid species dissolved in solution begins to self-assemble into an oriented aggregation from which a dense, oriented mono-layer of the invention is deposited. Accordingly, it will be appreciated that for processes utilizing an acid solution to provide an adsorbed mono-layer on the substrate surface, any arrangement which provides for removing the remaining solution from the substrate surface by progressively traversing the substrate surface with a substrate surface/solution surface interface in a manner that permits self-assembly of the acid to form a mono-layer of the acid on the surface can be employed. Deposition of a dense, oriented, adsorbed mono-layer of the acid using this progressive traversal of the substrate surface with the point of contact between an acid solution surface and the substrate surface is sometimes referred to herein for convenience as traversing the substrate surface with an acid solution meniscus.

The inventors have found that using the simple “dip” coating process described above, typically, a single deposition procedure provides about 90% coverage of the surface with a dense organic mono-layer. The surface area coverage can be increased by bonding the adsorbed mono-layer provided in a single procedure and repeating the “dip” coating procedure on a given substrate. This cycle of dip coating and bonding can be repeated until substantially the entire surface is covered in an organic mono-layer. In some cases, higher coverage in a single application can be obtained by increasing the concentration of the acid species in solution. Where that is impractical, for example due to solution aggregation or solubility problems, as described herein, or where the surface provides only weak adsorption of the acid species or is even attacked by higher concentrations of the acid species, the inventors have found that very low concentrations of the acid species can be employed in repeated cycles of the “dip” coating procedure to provide substantially complete mono-layer surface coverage over large surface areas.

To exemplify the improved surface coverage of coatings provided according to the present invention, when examining mono-layer films prepared by prior art techniques using microscopic surface-probing techniques, for example, atomic force microscopy, intact regions of the film, that is coverage of the surface without including an area devoid of film coverage, have sizes on the order of nanometer dimensions. In the films prepared by the present process, the inventors have surprisingly found the organic mono-layer films must be examined over regions of tens of microns in dimension to even locate a pinhole defect through which the thickness of the bonded mono-layer can be measured.

As is mentioned above, when solution methods are employed to provide a dense, oriented, adsorbed organic mono-layer, a solution having an acid concentration which is “low” or “below the critical micelle concentration” is preferably employed. The term “critical micelle concentration” is discussed by Kozo Shinoda in Solvent Properties of Surfactant Solutions, (1967), Marcel Dekker, Inc. N.Y., in Part 2 thereof, chapter 3, “Solvent Properties of Nonionic Surfactants in Aqueous Solutions”, beginning on page 42. The critical micelle concentration (CMC) for a species in solution refers to the concentration level at which the dissolved species is sufficient to form micelle structures Accordingly, at concentrations lower than the CMC the dissolved species exists as a monomolecular species which is surrounded by a solvent “shell”, and, at concentrations above the CMC, the dissolved species aggregate into micelle “domains” within the solution. As observed by Neves et al., discussed above, contact of surfaces with solutions containing aggregated structures, that is, micelles and bilayers, yields on surfaces contacted poly-layers of the dissolved materials. Accordingly, in process of the invention utilizing a solution of an acid to provide an adsorbed mono-layer, it is preferred to employ a solution having an acid concentration below the critical micelle concentration.

It will be appreciated that, for some acid and solvent combinations, the acid is too sparingly soluble in the solvent to provide a solution of sufficient concentration to even approach the point at which structures, for example, a bilayer, begin to form in solution. As is known, when a concentration of a dissolved species exceeds the saturation point in solution, the species begins to precipitate in a crystal form. Accordingly, from the standpoint of convenience, when solvents are employed with sparingly soluble acid species in processes of the invention, it will be appreciated that it is preferred to utilize acid solutions having an acid concentration below the point of solute saturation. Accordingly, as the term is used herein, a “low concentration” of the acid implies a concentration which is, as appropriate for the particular acid and solvent in view of the above discussion, either less than a saturated solution of the acid in the solvent employed or below the critical micelle concentration of the acid in solution. As explained in detail below, for the purposes of providing an adsorbed, oriented, dense, organic mono-layer according to the solution process embodiment of the invention, it is preferable to select solvents in which the acid is sparingly soluble.

In the solution process of providing an adsorbed mono-layer on the substrate surface, the solubility of the acid species in the solvent must also be considered. In general, it is preferred to use a solvent for which the acid species comprising the mono-layer has a lower affinity than it does for the surface. Accordingly, any solvent in which an acid species is highly soluble, and thus, which is capable of dissolving an adsorbed mono-layer of the acid from the substrate surface, is not preferred. Without wanting to be bound by theory, it is believed that choosing a solvent in which the acid species is slightly or sparingly soluble, as those terms are used in the formulating arts, aids the provision of a dense, oriented adsorbed mono-layer on the substrate surface when a solution process, for example, those described above, is utilized. It is believed that upon contacting the substrate surface with a solution comprising an acid species and a solvent in which the acid species is sparingly soluble, the affinity of the acid for the surface can provide a driving force for the acid to self-assemble into a dense, oriented, adsorbed mono-layer on the surface of the substrate.

It will be appreciated also that, in accordance with principles governing the adsorption affinity of the substrate surface for a given acid species, solvents having higher solubility for the acid, and acid concentrations which exceed those indicated above as preferred, may also be employed to deposit an adsorbed, dense, oriented mono-layer on the surface of a substrate. Without being bound by theory, it is believed that concentration and/or solvent conditions lying outside of those described above can be employed if the interaction of the organic acid species with the substrate surface upon which an adsorbed mono-layer of the acid is being deposited is sufficiently energetically favorable to promote the deposition a mono-layer of the acid species over the deposition of aggregates of the organic acid species and/or provide an equilibrium between the deposited and dissolved species that lies in favor of the deposited species. Accordingly, it will be appreciated that conditions which disfavor re-dissolving an adsorbed acid species back into solution during the deposition process and/or which disfavor the deposition of aggregates onto the surface, and/or which favor the re-distribution into a mono-layer of any acid aggregates deposited onto the surface, will permit employing deposition conditions lying outside of the preferred conditions described above and remain within the scope of the present invention process.

Bonding the Adsorbed Mono-Layer to the Substrate Surface

In the process of the present invention, after providing on the surface of a substrate a dense, oriented adsorbed mono-layer comprising an organic acid, the layer is bonded to the substrate surface in a bonding step which may be remote in time from the provision of the adsorbed mono-layer or contemporaneous with formation of the adsorbed mono-layer. The bonding step yields a mono-layer chemically attached to the substrate surface in the area in which it was adsorbed.

Without wanting to be bound by theory, when the substrate surface is an oxide, it is believed that evolution of water from the interface between the surface-associated acid functional groups of the organic acid species comprising the adsorbed mono-layer and the oxide surface of the substrate is integral to forming bonds between the adsorbed organic acid species and the oxide surface of the substrate. To this end, one method of providing the conditions necessary to form bonds between the organic acid species comprising the adsorbed mono-layer and the substrate surface is by heating the substrate and adsorbed mono-layer. Conveniently, this may be accomplished by placing the substrate and adsorbed mono-layer into an oven having a temperature in excess of about 100° C. for a sufficient period of time to cause substantially all of the organic acid species comprising the adsorbed mono-layer to form bonds with the oxide surface of the substrate. It will be appreciated that other means of supplying sufficient energy to the interfacial region comprising the adsorbed mono-layer and the substrate surface may be employed, for example, radiant heating and microwave irradiation.

It will be appreciated that the formation of the bonded organic acid species-based mono-layer is independent of the surface area density of physisorbed and chemisorbed water on the native oxide substrate. In fact, one advantage of the present invention process and the mono-layer provided thereby is that surface area coverage of the mono-layer, that is, the number of moles of surface bound species per area of surface, also sometimes referred to herein for convenience as the density of surface bound species, is not related to the density of conventionally reactive species on the native surface of the substrate. This aspect of the present invention permits a mono-layer to be applied to a selected area of the substrate surface which is essentially without voids. Complete coverage of a macroscopic area of the substrate surface by an organic acid-based, bound mono-layer can be accomplished by repeating the steps of the process described above. That is, providing an adsorbed, dense, oriented mono-layer of an organic acid followed by forming bonds between the organic acid species comprising the adsorbed mono-layer and the oxide surface of the substrate, until complete mono-layer coverage is achieved.

As mentioned above, substrates having surfaces other than oxides can also be provided with an organic mono-layer coating according to the present invention if the substrate surface comprises a plethora of functional groups which can be hydrolyzed by an organic acid, and if the surface is disposed to the application of a dense, oriented, adsorbed mono-layer comprising an organic acid. An example of such a surface is a naked silicon nitride ceramic surface, as described above. Other substrate surfaces will be apparent to those of skill in the art.

The Organic Acid

The provision of an organic acid-based mono-layer bound to the native oxide surface of a substrate requires the use of an organic acid species in the above-described process. As the term is used herein, an organic acid species comprises a molecule having at least one acid functional group selected from phosphonic acid (—PO₃H₂), carboxylic acid (—CO₂H), and sulfonic acid (—SO₃H), and a portion attached thereto which comprises an organic moiety. Preferred are organic acids containing a phosphonic or carboxylic acid functional group, with organic acids containing a phosphonic acid functional group being most preferred. The organic moiety attached to the acid functional group may optionally be substituted with one or more additional functional groups selected from the group consisting of hydroxyl, sulfonic acid, phosphonic acid, carboxylic acid, amino, alkyl, ether and thiol functional groups.

In general, it is preferred for acids used in the provision of an organic layer according to the present invention to comprise an organic moiety comprising from about 2 to about 40 carbon atoms, more preferably, from about 2 to about 20 carbon atoms. More preferred are acids comprising an organic moiety which is disposed to participate in a close-packing arrangement when the acid is adsorbed onto the surface of a substrate.

It will be appreciated that when a difunctional or polyfunctional moiety is employed, it is preferred to have the functional groups disposed on the organic moiety such that at least one of the functional groups is in a di-terminal relationship with the functional group having the strongest affinity for the surface. In this manner, when a mono-layer comprising a plurality of the organic acid species is adsorbed on the surface of the substrate having one acid functional group associated with the surface of the substrate, it will have the second functional group directed distal to the substrate surface and therefore, the second acid group will easily be accessible to participate in further chemical reactions.

Suitable organic moieties are selected from aromatic, heteroaromatic, and aliphatic moieties, including saturated and unsaturated alkyl moieties. Furthermore the organic moiety may be optionally substituted with additional aliphatic or aromatic moieties and one or more functional groups. Aliphatic moieties may be linear, branched, or cyclic and may be saturated or unsaturated. Aromatic moieties may comprise oligomeric compounds for example, biphenyls, polymeric compounds, for example linear phenylenes, for example sexiphenylene, and polycyclic-fused aromatic ring systems, for example pentacene and anthracene and their heterocyclic analogs. Heteroaromatic moieties may comprise monomeric moieties, for example pyrroles and thiophenes, and oligomeric and polymeric heterocyclic moieties, for example, oligothiophenes, for example quarterthiophenes and sexithiophenes.

Preferred organic moieties comprise linear or branched alkyl moieties having from about 2 to about 40 carbon atoms which are optionally substituted additionally (thus providing a di- or polyfunctional acid from which the organic mono-layer of the invention is prepared) with one or more functional groups selected from the group consisting of hydroxyl functional groups, amino functional groups, carboxylic acid functional groups, carboxylate functional groups, phosphonic acid functional groups, phosphonate functional groups, ether functional groups and thiol functional groups. Preferred also are organic moieties selected from the group consisting of substituted and unsubstituted pentacenes, substituted and unsubstituted anthracenes, substituted and unsubstituted thiophenes and polythiophenes, and substituted and unsubstituted xylenes.

Also preferred are organic moieties which are based on derivatives of the art recognized electron acceptor and donor molecules TCNQ and TTF, the structures of which are illustrated below in Structure I. As is known, TCNQ and TTF are typically used as building blocks in the provision of organic conductors.

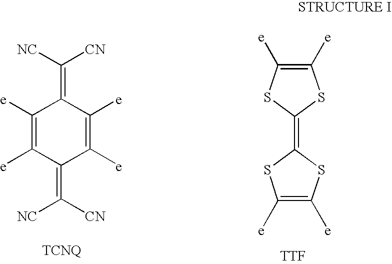

Molecular derivatives of TCNQ with altered electron acceptor properties are known and have been described, for example, by Yamashita et al. in Journal of Materials Chemistry, (1998), 8(9), on pages 1933-1944, which is incorporated herein in its entirety by reference. These art-recognized TCNQ derivatives comprise substitution (with reference to Structure I, at the structural positions designated by “e”) with electron withdrawing substituents, for example chlorine and fluorine, to enhance its properties as an electron acceptor. In addition, it is known that TCNQ can be substituted, either alternative or in addition, at the positions occupied by the cyano groups with electron withdrawing groups to further enhance its electron acceptor properties.

Known also are TTF derivative compounds with altered electron donating properties. Such molecules have been described, for example, by Hasegawa et al. in Synthetic Metals (1997), 86, pages 1801-1802, which is incorporated herein in its entirety also by reference. As has been described, TTF can be substituted, again with reference to Structure I, at the positions designated by “e” groups with electron donating groups to enhance its electron-donor properties.

In accordance with these known principles, and as mentioned above, another group of organic moieties for inclusion in organic acids for use in the preparation of an organic layer of the present invention are those which contain an organic moiety based on either a TCNQ or a TTF molecule or one or more of their derivatives. One example is shown in Structure II, which comprises a phosphonic acid containing an organic moiety (shown in brackets) based on a TCNQ derivative structure.

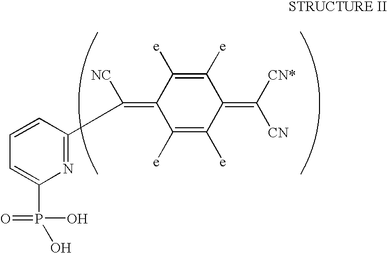

The phosphonic acid derivative shown comprises the fundamental TCNQ structure in which a pyridylphosphonic acid functional group has been substituted for one of the cyano groups of the TCNQ parent compound. As will be appreciated, and in accordance with the discussion above, this derivative can optionally have electron withdrawing functional groups substituted at one up to all of the positions designated “e” in the structure of Structure II. In addition. It will also be appreciated that any of the remaining cyano groups of the phosphonic acid of Structure II can be, additionally or instead, substituted with electron withdrawing groups. It will also be appreciated that other acid groups can be substituted for the phosphonic acid shown, as well as additional acid groups added to the phosphonic acid of Structure II. For example, a diphosphonic acid derivative of TCNQ has been reported, Katz, H. E., and Schilling, M. L., Journal of Organic Chemistry, (1991) 56, pages 5318 to 5324, which is incorporated herein in its entirety by reference. In the Katz bisphosphonic acid molecule (with reference to Structure II above) the cyano group marked with an asterisk (as shown in Structure II, the cyano group on the upper right-hand side) is substituted by a second pyridylphosphonic acid functional group, providing a symmetrical bisphosphonic acid. It will be appreciated that numerous other variations and modifications of derivatives from which an organic mono-layer of the present invention can be prepared are possible.

In a like manner, it will be apparent that addition of an acid functional group, for example, a pyridyl phosphonic acid group, at one or more of the positions designated “e” in the TTF structure shown in Structure I will provide an organic acid useful in preparing coatings of the invention which have electron-donating properties. Accordingly, it will be appreciated also that films having a mixture of the two species can be prepared which will have electronic conducting properties analogous to organic electron conductors prepared from the parent TCNQ and TTF compounds. Other organic acid derivatives of both the TCNQ and TTF parent compounds will be apparent to those of skill in the art.

Also preferred are phosphonic acids are selected from the group consisting of nitrophenylphosphonic acid, benzylphosphonic acid, butylphosphonic acid, octylphosphonic acid, duodecylphosphonic acid, octadecylphosphonic acid, substituted and unsubstituted anthracenephosphonic acids, substituted and unsubstituted pentacenephosphonic acids, substituted and unsubstituted quarterthiophenephosphonic acids, 11-hydroxyundecylphosphonic acid, substituted and unsubstituted xylyl-phosphonic acid, omega-substituted phosphonic acids having a hydrocarbon moiety comprising from about 2 to about 20 carbon atoms, wherein the omega substituent is selected independently for each occurrence from the group consisting of a carboxylic acid, hydroxyl, amino, phosphonic acid, ether, polyether, and thiol functional groups, and combinations of two or more of these acids.

Additionally preferred are carboxylic acids are selected from the group consisting of alkylcarboxylic acids having from about 2 to about 40 carbon atoms, salicylic acid and substituted and unsubstituted alkyl salicylic acids, benzoic acid, and substituted benzoic acids, wherein said substituent comprises at least one member selected from the group consisting of a hydroxyl functional group, an amino functional group, a carboxylic acid functional group, and linear or branched, substituted or unsubstituted alkyl moieties having from about 2 to about 20 carbon atoms which are optionally functionalized with one or more functional groups selected from the group consisting of hydroxyl, amino and carboxylic acid functional groups.

It will be appreciated also that, to the extent that they are compatible with regard to affinity for the surface and with regard to packing arrangement, mixtures of two or more of the organic acid species described above may be used in the process of the invention.

The Substrate Surface

As described herein, the present invention is a method for bonding to the surface of a substrate a mono-layer comprising a plurality of an organic acid species. Suitable substrates are selected from materials which have metallic, conducting, semiconducting, and insulating properties, as those terms are defined, for example, by A. West in Basic Solid State Chemistry, second edition, John Wiley & Sons, New York, pp. 110 -120, which is incorporated herein in its entirety by reference. Examples of substrates suitable for use in the process of the invention include, but are not limited to materials which possess a native oxide surface, that is, they comprise an oxide or form a native oxide upon exposure to the ambient environment. Non-limiting examples of oxide materials include bulk metal oxides, for example silica and alumina, conducting oxides, for example, indium doped tin oxide and zinc/indium doped tin oxide, and oxide insulators, for example, low dielectric constant glass in gate insulator material of integrated circuits. Non-limiting examples of materials which form native metal oxide surfaces upon exposure to the ambient include metals which acquire a non-ablating oxide coating upon exposure to the ambient environment, for example, titanium, titanium alloys, aluminum, and aluminium alloys. Additional examples of materials which acquire a native oxide layer upon exposure to the ambient are ceramic materials, for example, silicon nitride and semiconductors, for example silicon. Also suitable for application of a coating of the present invention are materials which have an oxide coating imparted to them intentionally, for example, thick film oxide insulators in semiconducting devices, and those which can be derivatized to have an oxide surface, for example, gallium arsenide, gallium nitride, and silicon carbide. Also suitable for use in the provision of a bonded mono-layer of the present invention are naked surfaces which can undergo hydrolysis and which have an adsorption affinity for carboxylic or phosphonic acid functional groups, thus permitting the adsorption of a dense, oriented mono-layer of organic acid species containing functional groups which can be bonded to the surface utilizing the process of the present invention, as mentioned above, for example, but not limited to, silicon nitride.

Particularly preferred substrates are those which are useful in preparing electronic or mechanical devices for contact with biological tissue or fluids. An example of those useful for the preparation of electronic devices are thick oxide insulating layers on gate junctions for use in bio-electronic sensors which are suitable for in vivo and in vitro diagnosis and monitoring of conditions. An example of a surface useful in the preparation of mechanical devices is an implantable material, for example, a titanium reinforcing member useful for in vivo implant in the repair of bone tissue.

As mentioned above, suitable surfaces include the surfaces of semiconductor substrates, for example silicon single crystal surfaces. They include also the surfaces of polycrystalline substrates, for example, metals, for example titanium and its alloys, aluminium and its alloys, and silicon. Also included are the surfaces of amorphous substrates, for example, the surface of an oxide conductor or oxide insulator. Examples of conductive oxides include Fe₃O₄, tin oxide doped to conduction with indium and/or zinc, zinc oxide doped to conduction with aluminium, zinc oxide, and sub-stoichiometric oxides, for example, TiO and VO.

Also preferred are ceramic substrates, for example, silicon nitride and silicon carbide, and semiconductors, for example germanium and semiconducting germanium-based compounds.

When oxide substrate surfaces are used, in general, the oxide surface must be prepared for the deposition of a mono-layer by cleaning the surface to remove residual metals and organics, generally by an oxidation treatment followed by a water rinse. For surfaces that are stable toward such treatment, for example, a single crystal or polycrystalline silicon wafer surface, the surface may be treated with the standard hydrogen peroxide/sulfuric acid “piranha” solution followed by a water rinse and a second treatement with a standard hydrogen peroxide/hydrochloric acid “buzzard” solution, in the manner typically followed for cleaning silicon wafers prior to fabricating integrated circuits on the wafer. In general, the process of the invention affords best results on oxide surfaces which are devoid of free base species, zero-valent metals, and residual hydrocarbon species. However, even for surfaces which do not lend themselves to a rigorous cleaning to semiconductor standards, for example, conducting oxides, the process of the invention will still provide a mono-layer exhibiting good surface conformation with the oxide surface of the substrate. Other cleaning methods applicable to particular surfaces for the removal of the unwanted species typical of those surfaces will be apparent to those of skill in the art.

### EXAMPLES

While the present invention is widely applicable to hydrolyzable surfaces, the following examples demonstrate the deposition of a mono-layer of an organic layer based on either a phosphonic or a carboxylic acid on the oxide surface of a single crystal silicon substrate, a titanium alloy substrate, and an indium doped tin oxide substrate. The examples are intended to illustrate the process of the invention and the films formed thereby and are not meant to limit the scope of the invention. It will be appreciated that there are many modifications possible to the materials and process steps exemplified below which still fall within the scope of the inventive process and films.

### Example I

### Deposition of Phosphonic Acids on a Silicon Substrate

For all of the examples using a silicon substrate the substrate was prepared as follows. A single crystal polished 12″ wafer of silicon (100) (stock item from University Wafer) was cut into square coupons by scoring and breaking the wafer. The coupons had a thickness of approximately 0.55 mm (the thickness of the wafer slice) two sets of approximately parallel edges, each 8 mm long, and accordingly two 64 mm² square faces. Trace metals and organics were removed from the coupons by first boiling them for about 15 minutes in a sulfuric acid/hydrogen peroxide solution (1:3 v/v of concentrated (95 to 97%) aqueous H₂SO₄:30% H₂O₂, also referred to herein for convenience as a pirana solution). After treatment with pirana solution, the coupons were rinsed with about 6 to 7 aliquots of streaming deionized water. The total volume of the aggregated rinse water was about 140 ml. Following rinsing, the coupons were boiled for about 15 minutes in a hydrochloric acid/hydrogen peroxide solution (1:1 v/v 32% aqueous HCl:30% H₂O₂, also referred herein for convenience as a “buzzard” solution). Following the treatment in buzzard solution the coupons were rinsed with 6 to 7 aliquots of flowing 18.2 megaohm deionized water (total volume about 1 liter) and dried by subjecting to a vacuum of about 10 millitorr for at least 24 hours.

For all of the examples, deposition of a phosphonic acid-based mono-layer onto the oxide surface of a silicon substrate was carried out by adsorbing a mono-layer comprising a selected phosphonic acid to the 0.5 cm² faces of the substrate, followed by heating the substrate and adsorbed mono-layer to form bonds between the oxide functional groups comprising the substrate surface and the phosphonic acid species comprising the adsorbed mono-layer.

For all examples, the following procedure was used to apply an adsorbed phosphonic acid-based mono-layer to the substrate surface. A silicon substrate coupon prepared as described above was placed into a holder designed to suspend the substrate in a phosphonic acid solution contained in a tall, narrow diameter beaker (tall beaker), thus providing for a comparatively long column of the acid solution for a given acid solution volume. The holder is configured to hold the coupon immersed in the acid solution and orient two opposite edges and the 64 mm² faces of the coupon substantially perpendicular to a plane that includes the surface meniscus of the phosphonic acid solution (meniscus plane). A solution of the selected phosphonic acid at the concentration indicated below was prepared by dissolving a weighed amount of the acid in tetrahydrofuran (THF, article of commerce, technical grade solvent, distilled from sodium benzophenone prior to use) at ambient temperature.

About 40 ml. volume of the phosphonic acid solution was placed in a tall beaker having a 50 ml volume. Utilizing the holder, the substrate was suspended in the beaker such that its upper most edge was immersed below the solution meniscus plane. Immediately after immersion of the coupon into the solution, solvent was permitted to evaporate from the beaker, reducing the volume of the solution and permitting the phosphonic acid solution meniscus to traverse the faces of the coupon (substrate surface) suspended therein as the solvent evaporated. Evaporation was carried out under ambient conditions until the meniscus plane of the remaining solution resided below the bottom edge of the coupon. As described above, a tall beaker was choose as a vessel for the bulk solvent to minimize the amount of solvent which needed to be evaporated to traverse the coupon surface with the acid solution meniscus, and thus minimize the change of concentration in the acid solution in the beaker during deposition of an adsorbed mono-layer of the phosphonic acid onto the substrate surface. The amount of acid used in preparing the solution was selected so that, even after the evaporation step, the remaining bulk acid solution comprised an acid concentration which is below saturation for the solution. For example, for deposition of 11-hydroxyundecylphosphonic acid, a solution having an initial concentration of 0.1 mM in THF was prepared. After evaporation, the residual solution had a 33% increase in concentration, which is less than the estimated room temperature saturation concentration of from about 25 mM to about 50 mM for this acid in THF.

A number of silicon coupons were prepared with adsorbed phosphonic acid mono-layers according to the above-described procedure. The acid utilized and its concentration in the solution used for preparing an adsorbed mono-layer in each deposition is reported in Table I.

TABLE I

| Example | | Solution Conc.* |
|---|---|---|
| No. | Acid Employed | (mM in Acid) |
| 1A | 11-hydroxyundecylphosphonic acid | 0.035 mM |
| 1B | α-quarterthiophene-2-phosphonic acid | 0.1 mM |
| 1C | octadecylphosphonic acid | 1.0 mM |

*Solutions were prepared by dissolving a weighed amount of the acid equal to one-tenth the number of indicated millimoles in 100 ml of ambient temperature tetrahydrofuran (THF) which had been freshly distilled from sodium benzophenone.

After adsorbing a mono-layer of the acid to the substrate, each coupon was placed in a convection oven operating at about 130° C. and heated for about 48 hours. After 48 hours the coupons were removed from the oven and cooled in the ambient to room temperature. The coupons were then treated to remove any adsorbed or poly-layer aggregated material by sonication in an ultrasonic bath (Branson) according to the following procedure.

Organic mono-layers based on 11 -hydroxyundecylphosphonic acid were sonicated for about 30 minutes in a triethylamine/ethanol solution that was heated to about 50° C. The coupons prepared with other mono-layer species were sonicated in a 0.5 M potasium carbonate solution (2:1 v/v ethanol/water, also referred to herein for convenience as “carbonate rinse solution”) at ambient temperature for about 20 minutes. It has been found that extended sonication (that is, sonication for periods of about 2 hours or longer) can etch away the silicon substrate. Accordingly, to prevent removal of the organic mono-layer from the surface of the silicon substrate by undercutting it at the unprotected edges of the coupon, excessive sonication periods in carbonate rinse solution are avoided.

For each acid species listed in Table I used to prepare a mono-layer covered substrate, coupons having a substrate based on the listed phosphonic acid were analyzed to verify the nature of bonding to the substrate surface, the thickness of the layer bonded to the substrate and the orientation of the species comprising the layer. Parallel studies (described below) were also carried out on specially prepared quartz micro-balance crystals to determine the packing density of the species comprising the organic mono-layer after bonding to the surface.

To verify the functional group bonded to the substrate in the organic mono-layer, coupons having a dense, organic mono-layer prepared according to the above-described procedure were analyzed by specular reflectance infra-red spectroscopy (IR, Midac Model 2510 Spectrometer equipped with a Surface Optics Corp. specular reflectance head) in accordance with known procedures. IR analysis performed on each sample confirmed that bonding occurred between the oxide functional groups of the oxide surface of the substrate and phosphonic acid functional groups of the constituents of the adsorbed mono-layer. To determine the thickness of the organic layer bonded to the substrate, and verify the mono-layer character of the organic layer bonded to the substrate, coupons prepared according to the above-described procedure were also examined by X-ray reflectivity and by Atomic Force Microscopy.

Atomic Force Microscopy Measurement of Dense Organic Mono-Layers on Silicon Substrates

Atomic Force Microscopy (AFM) analysis of the organic mono-layer on substrates was carried out on a Digital Instruments Multimode Nanoscope IIIa SPM equipped with silicon tips (Nanodevices Metrology Probes, resonant frequency: 300 kHz, spring constant: 40 N/m) in tapping mode.

X-Ray Reflectance Measurement

X-ray reflection measurements were performed at the National Synchrotron Light Source (NSLS) using beam line X10b at a wavelenght of λ=0.087 nM. Measurements were performed in reflectivity mode (Θ-2Θ) resulting in a momentum transfer, q_{z}, along the surface normal (q_{z}=4τ/λ sin Θ). A NaI detector was used. The sample slit was set to 0.6 mm and the detector slit was set to 0.8 mm. Rocking scans were performed to verify background level. The incident beam was isolated from material other than the sample by sideways clamping of the sample. Analysis of the films was performed in air. The data were analyzed using a free program based on Parratt formalism (dynamic scattering).

Data from the AFM and X-ray spectroscopy for films prepared for each of examples 1-3 is presented below in Table II. In the case of α-quarterthiophene-2-phosphonic acid, the X-ray analysis also confirms that the surface roughness of the dense organic mono-layer deposited on the substrate surface did not exceed that of the underlying substrate surface prior to the deposition of the mono-layer. This demonstrates that the mono-layer of the invention exhibits a high degree of surface conformation.

TABLE II

| | Acid Species | | “Length” of Acid |
|---|---|---|---|
| Exp. | Comprising | | Species Basing |
| No. | Mono-Layer | Thickness of layer | Mono-layer (theory) |
| 1c | octadecyl- | 1.8 nM (AFM) | 2.5 nM |
| | phosphonic | | |
| 1b | α-quarterthiophene- | 1.8 nM (AEM/X-ray) | 1.9 nM |
| | 2-phosphonic | Slight disordering | |
| | | (X-ray) | |
| 1a | 11-Hydrooxy- | 1.8 nM(AFM) | 1.9 nM |
| | undecylphosphonic | | |

These data in Table II indicate that mono-layers are formed using any of the example phosphonic acid species, and in general, the mono-layers represent an orientation of the phosphonate species comprising the organic mono-layer that is only slightly tilted from perpendicular with the substrate surface.

Quartz Crystal Microbalance Packing Density Measurments

The density of the phosphonic acid-based surface bounded mono-layer species prepared in accordance with the above described procedure was measured by repeating the procedure using a silicon electrode-equipped quartz microbalance crystals in place of the silicon substrate. The use of these crystals to model oxide surfaces and their use in measuring mass gain in the crystal due to surface attached species is described in detail by Gawalt et al. in Langmuir 2003, Vol. 19, pp 200-204, which is incorporated herein in its entirety by reference. The deposition procedure described above was followed using either a 0.05 mM octadecylphosphonic acid/THF solution or a 0.0025 mM α-quarterthiophene-2-phosphonic acid/THF solution. After each treatment cycle (adsorbing a dense, phosphonic acid-based mono-layer and bonding it to the oxide surface functional groups) crystals containing the bonded dense phosphonic acid-based mono-layer were rinsed by flushing in a stream of “carbonate rinse” solution followed by a deionized water stream. Residual water was then evaporated from the crystals by subjecting them to a vacuum of about 10 millitorr for about two hours. This rinse and evaporate cycle was repeated until the crystals displayed a constant oscillation frequency after successive cycles indicating that all multi-layer species had been removed from the surface. Micro-balance measurements were performed on the crystals thus prepared. After each microbalance measurement, the crystal was subjected again to a treatment cycle until an asymptote was reached in mass gain. The density of surface bonded species comprising the dense, organic mono-layer bonded to the oxide surface of the quartz crystal are reported below in Table III.

TABLE III

| | Species Comprising | Surface Loading | Packing Density |
|---|---|---|---|
| Exp. No. | Mono-Layer | (nMol./cm²) | (Å²/molecule) |
| 1C | octadecylphosphonic | 0.82 | 18.5 |
| | acid | | |
| 1B | α-quarterthiophene-2- | 0.66 | 25.1 |
| | phosphonic acid | | |
| 1A | 11-Hydroxy- | 0.82 | 20.5 |
| | undecylphosphonic | | |
| | acid | | |

The data in Table III indicate that octadecylphosphonic acid-based mono-layers acquire a packing density that corresponds to approximately 18.5 angstroms squared/molecular unit comprising the mono-layer. This is approximately the value observed in crystals of aliphatic materials for close-packed aliphatic chains. The data in Table II indicate also that a-quarterthiophene-2-phosphonic acid-based mono-layers acquire a packing density that corresponds to approximately 25.1 angstroms squared/molecular unit comprising the mono-layer. This is approximately the value observed in crystalline a-quarterthiophene-2-phosphonic acid (23.4 to 25.6 angstroms squared/molecular unit). Finally, the data in Table II indicate also that 11-hydroxyundecylphosphonic acid-based mono-layers acquire a packing density that corresponds to approximately 20.5 angstroms squared/molecular unit. This value is similar to the reported value for the packing density of a dense mono-layer of octadecylphosphonic acid adsorbed on mica surfaces. These data indicate that the monolayer has a dense packing arrangement on the surface of the substrate. As mentioned above, the packing reported in the art for sparse mono-layer adsorption of octadecylphosphonic acid on mica was not observed by earlier workers observing octadecylphosphonic acid adsorption on surfaces other than mica.

### Comparative Example A

### Treatment of Silicon With Bulk α-Quarterthiophenephosphonic Acid Solution

A 0.1 mM THF solutuion of α-quarterthiophene-2-phosphonic acid was prepared as described above. A silicon substrate coupon prepared as described above was immersed in an aliquot of the solution at ambient temperature for 3 days. The coupon was then removed from the solution and rinsed in accordance with the procedures described above. The rinsed coupon was heated, as described above, no organic layer formation could be observed.

A 100 ml aliquot of the a-quarterthiophene-2-phosphonic acid solution prepared above was heated to 60° C. A silicon substrate coupon, prepared as described above, was immersed in the warm acid solution for 14 days. At the end of this time, the coupon was removed from the solution, dried, and heated in an oven in accordance with the above-described procedure. Subsequent analysis of the deposited organic layer by AFM indicated that it comprised multiple layers of a phosphonate moiety derived from the α-quarterthiophene-2-phosphonic acid used in its preparation.

The next set of examples exemplify the further derivatization of a dense organic mono-layer of the invention based on an omega-functionalized phosphonic acid.

### Example 4

### Peptide Derivatization of a Dense Organic Mono-Layer Bonded to a Silicon Substrate

In this example, a silicon substrate having a dense, organic mono-layer based on 11-hydroxyundecylphosphonic acid according to the above-described process for Example 1A was further derivatized by attaching a biomolecule to the organic layer using the terminal hydroxy functional groups present on the constituents species comprising the mono-layer. Thus, the hydroxy functional groups were derivatized by conversion to a maleimide-derivative ester (that is, 3-maleimido-propionate ester, also referred to herein sometimes for convenience as “the derivative ester”) and the derivative ester was reacted with the cysteine residue of a tetrapeptide, Arg-Gly-Asp-Cys (RGDC) to yield a tetrapeptide bonded via a thiol ester functional group to the surface-bonded organic mono-layer. The RGDC peptide used in this example is the fibronectin RGD-containing cell-binding peptide derivatized by adding a cysteine residue at the C-terminus, and is commercially available (American Peptide).

The sequence of derivitization reactions leading to the bound peptide was carried out according to the following procedure. Under anhydrous conditions, a coupon having a dense, organic mono-layer prepared using 11-hydroxyundecylphosphonic acid prepared in accordance with Example 1A (above) was placed into about 15 mL of a 1 mM 3-maleimido-(propionic-acid-N-hydroxysuccinimide) ester acetonitrile solution which had been prepared from rigerously dried acetonitrile. Maintaining the solution under anhydrous conditions, the coupon was stirred in the solution for about 24 hours at ambient temperature. The coupon was then removed from the solution under ambient conditions and rinsed by sonication with 3 aliquots of acetonitrile in a Branson® ultrasonic bath. IR analysis in accordance with the above described procedure indicated that to a substantial degree the hydroxyl functional groups terminating the phosphonate moiety comprising the organic mono-layer bound to the substrate surface were converted to the derivative ester adduct.

A solution comprising about 10 mg of the above-described RGDC peptide in 15 mL of doubly distilled, Millipore™—filtered water was prepared and adjusted to pH 6.5 using 0.05M aqueous NaOH. Coupons containing the organic mono-layer with the derivative ester adduct prepared above were placed into the RGDC solution and stirred at ambient temperature for about 24 hours. The coupons were removed from solution and rinsed by sonication in doubly distilled water. The coupons were transferred to vacuum line and dried in vacuo (approximately 10 millitorr) for 24 hours. FTIR analysis in accordance with the above described procedure indicated that the sulfhydryl group of the cysteine residue of the RGDC peptide surface had formed a thiol ether bond with the derivative ester adduct bound to the organic mono-layer. This was demonstrated by changes in the carbonyl region of the maleimide-derivative ester and broadening in the carboxylate region (˜1700 cm⁻¹). These IR signatures were found to persist even after two solvent rinses, indicating the presence of the RGDC tetrapeptide bound to the coupons.

The RGDC-derivatized silicon coupons prepared as described above were contacted with living cells to determine the ability of the surface to stiumlate cell growth and attachment to the surface. The following cells were use in contact experiments:

(a) Human fetal osteoblasts (HFOB 1.19; ATCC) were maintained in a 1:1 mixture of Ham's F12 and Dulbecco's modified Eagle's medium (DMEM), without phenol red (GIBCO, BRL), 10% fetal bovine serum (Hyclone Laboratories) and 0.3 mg/ml G418 Geneticin (Invitrogen);

(b) NIH 3T3 cells grown in DMEM and 10% calf serum (Hyclone Laboratories);

(c) human melanoma cells (A375), human fibrosacroma cells (HT1080) and SV40-transformed human fibroblasts (WI38-VA13) grown in DMEM and 10% fetal bovine serum; and

(d) chinese hamster ovary cells expressing α4(CHOα4), α5(CHOα5) or αvB3 integrins grown in DMEM, 10% fetal clone II serum (Hyclone Laboratories), 1% non-essential amino acids, and 1 mg/ml Geneticin.

The cells were grown in culture dishes in the indicated medium and released from tissue culture dishes using 2.5% trypsin in 0.2 mg/ml EDTA in PBS and resuspended in complete medium. An aliquot of cells (approximately 5×10⁴ cells) was added to wells containing Si substrates which were derivatized as described above with RGDC and blocked with 1% BSA in PBS for 30 minutes. The cells were allowed to multiply on the derivatized surfaces for about 1.5 hours, periodically being examined by optical microscopy for the number of cells adhered to the surface and the degree of intracellular organization of the actin cytoskeleton into stress fibers and the formation of focal adhesions (protein-rich complexes that connect actin stress fibers to integrin receptors and the extracellular matrix). The organization and proliferation was detected by staining of the adhered cells and structures with fluorescent dye visualizing using flourescent microscopy.

These same cell adhesion experiments carried out over a period of 7 days showed continued proliferation of numbers of cells adhered to the substrate modified organic mono-layer surface. This demonstrates the stability of the dense organic mono-layer films on the surface of the substrate to physiological conditions. When the cell coverings were stripped off of the modified organic mono-layers with protease trypsin, they could be reused to incubate new cells using the above-described procedure.

The next example illustrates that large biomolecules, in this example an antibody, can also be attached to a substrate using the dense, organic mono-layer provided by the present invention.

### Example 5

### Antibody Derivatization of a Dense Organic Mono-Layer Bonded to a Silicon Substrate

Substrates having a dense organic mono-layer based on 11-hydroxyundecyl phosphonic acid prepared according to Example 1A were derivatized by placing the coupons into a 5 mM acetonitrile solution of disuccinimidyl glutarate (DSG, Pierce) at ambient temperature (about 25° C.) for 24 hours. The solution was prepared and used under anhydrous conditions (material transferred in a nitrogen glove box and acetonitrile handled using cannula technique after distillation from sodium metal. After 24 hours, the glutarate-derivatized coupons were rinsed with fresh acetonitrile and handled in an inert environment prior to use.

Rabbit anti-mouse IgG (Pierce, used as received) was coupled to the glutarate-derivatized mono-layer by placing the derivatized coupons into a 100 mg/ml phosphate buffer solution (PBS) at ambient temperature for 30 minutes. At the end of 30 minutes, the reaction was quenched and the coupon washed with aliquots of 50 mM Tris-HCl solution (pH 7.4). The coupons were incubated in a solution having a 10 microgram/ml concentration of either anti-α4 integrin antibody P1H4 (Chemicon) or anti-α5 integrin antibody SAM-1 (Cymbus Technology, Ltd.), the solutions being used as received from the suppliers. Following this the coupons were removed from the antibody solutions and washed with PBS and blocked with 1% BSA in PBS for 30 minutes.

Cells expressing either α4(CHO α4) tagged with Cell Tracker Orange or α5(CHOα5) tagged with Cell Tracker green were prepared by treating them with the respective fluorescent tag for 30 minutes at 37° C. prior to release from the culture dish using the procedure described above. A mixture of the tagged cells was incubated with each of the antibody derivatized surfaces using the procedure described above. After about 2.3 hours of contact time, the coupons were visualized using the appropriate wavelength of light. It was observed that when an α5-derivatized surface was incubated with a mixture of cells, to a substantial degree only the α5-expressing cells proliferated on the surface and in the same manner, substantially only the α4-expressing cells prolliferated on the α4-derivatized surface. These observations demonstrate that the dense, organic mono-layers provide a path for preparing surfaces which are specific in their interaction with biomaterials.

The next group of examples illustrates the utility of the process of the present invention in application of a dense, surface compliant, organic mono-layer onto the surface of an amorphous planar oxide conductor and onto a native oxide surface of a curved metal surface.

### Example 6

### Deposition of a Dense Organic Mono-Layer Onto an Indium Doped Tin Oxide Surface

A dense organic mono-layer was deposited onto the conductive oxide surface of a glass substrate bearing a 125 nM thick layer of tin oxide doped with indium to a conducting state (ITO/glass, Colorado Concept Coatings). The substrate was prepared by scoring and breaking a plate of the ITO/glass to give coupons measuring 100 nm². The ITO surface of the coupons was cleaned by sonication in accordance with the above-described process in a 2 wt. % detergent solution (Tergitol®) for 30 minutes. The detergent cleaning was followed by copious rinsing under flowing deionized water. Each coupon was then boiled for 15 minutes in each of the following solvents: methanol; isopropanol; and methylene chloride. The coupons were then dried under flowing anhydrous nitrogen and stored under an anhydrous nitrogen blanket until use.

A dense, organic mono-layer was deposited onto the surface of the ITO coupons prepared above using about 40 mL of a 0.0024 mM THF solution of α-quarterthiophene-2-phosphonic acid in accordance with the procedures described above for providing a mono-layer film on a the surface of a silicon substrate (Example 1), with the evaporation period to traverse the ITO coupon surface with the acid solution meniscus lasting about 3 hours. The mono-layer film thus prepared was examined by IR spectroscopy and by AFM in accordance with the procedures described above. The results of this examination confirm that the layer deposited on the surface is surface conforming, covers substantially the entire surface and is of mono-layer dimension.

Extensive sonication of the ITO coupons prepared above in a 5 wt. % triethylamine in THF solution under ambient conditions (in excess of about 1 hour) showed no change in the surface bonded organic layer. This demonstrates that the organic mono-layer is robustly adhered to the ITO surface of the substrate.

### Example 7

### Deposition of a Dense Organic Mono-Layer Onto a Curved Metal Surface

A dense organic mono-layer was deposited onto the native oxide surface of sections of 6 mm diameter arterial stents made from medical grade nickel/titanium alloy (Nitinol®) and from 2 mm diameter surgical grade type 316 stainless steel (both stent samples obtained as stock items from UTI Corporation Stent Technologies Div.).

In preparation for applying a bonded, mono-layer coat according to the present invention, the nickle/titanium stents were cut into pieces about 15 mm in length and the stainless steel stents were cut into pieces about 17 to 20 mm long. Prior to deposition, the stent pieces were cleaned according to the following procedure. The stents were cleaned by sonication (Branson) for 30 minutes in a Turgitol® distilled water solution according to manufactures directions, and rinsed by sonication for 15 minutes in each of a distilled water bath (house DI water), methylene chloride (technical grade, used as received), and sonicated for 15 minutes successively in each of three methanol baths. After this solution treatment procedure the stent pieces were dried in air in a 150° C. oven for at least 12 hours.

A solution comprising 3.2 mg of phosphonoundecanol (a di functional phosphonic acid comprising a phosphonic acid head group, a terminal alcohol functional group and an 11 carbon atom linear alkyl chain between the two functional groups) in 20 ml of THF freshly distilled from sodium benzophenone. The stents were coated using the procedure described above for the silicon wafer coupons, except that they were lowered into the acid solution lengthwise and suspended from a fine wire passed through the stent piece. After coating the stent pieces were placed into a tube furnace and heated to 125° C. for 24 hours. After cooling to ambient temperature in air, the coated stent pieces were sonicated in fresh methanol for 30 minutes and dried under a vacuum of about 10 torr for about 12 hours.

The mono-layer coated stent pieces prepared as described above were further functionalized by placing the stent pieces into an 11.6 micromolar acetonitrile solution of Alexafluor-546 carboxylic acid succinimidyl ester® (Molecular Probes) for 24 hours, forming an Alexafluor-546 ester® adduct with the hydroxy functional groups of the mono-layer. The derivatized stent pieces were rinsed by sonication in fresh acetonitrile for 10 minutes and stored under vacuum (about 10 torr) until they were examined by fluorescent microscopy. The fluorescent microscopic examination of the derivatized stents indicates a uniform surface coverage of the fluorescent species. This demonstrates that the present process can be used to provide a dense organic mono-layer on even complex metallic shapes.

What is claimed is:

1. A process for providing on at least a portion of a substrate having a surface that comprises hydrolyzable functional groups onto which a dense, oriented mono-layer, comprising at least one organic acid species has been adsorbed, a dense, oriented, bonded mono-layer, the process comprising forming with one or more of said surface hydrolyzable functional groups a bond that includes at least one of an associated acid functional group of each of at least some of the adsorbed organic acid species.

2. The process of claim 1 wherein said bond-forming comprises heating said substrate and adsorbed mono-layer until at least a portion of said adsorbed mono-layer is bonded to said substrate surface.

3. A process for providing a dense, oriented mono-layer on at least a portion of the surface of a substrate comprising:
(i) providing a substrate surface comprising a plurality of hydrolyzable functional groups;
(ii) adsorbing onto at least a portion of said substrate surface at least one organic acid species, characterized in that it has at least one acid functional group, in a quantity sufficient to form a dense, oriented mono-layer comprising, at the interface comprising the adsorbed organic acid species and the surface of said substrate, at least some of said acid functional groups in bond-making proximity to said substrate surface hydrolyzable functional groups; and
(iii) bonding at least a portion of said acid functional groups at said interface with said hydrolyzable functional groups comprising the surface of said substrate.

4. The process of claim 3 further comprising repeating steps (ii) and (iii) until said mono-layer covers, substantially without void areas, the entirety of said portion of said substrate surface to be provided with a dense, oriented organic mono-layer.

5. The process of claim 3 wherein said bonding step (iii) comprises supplying to said interface sufficient heat energy of sufficient duration to cause at least some of the acid functional groups at said interface to form a chemical bond with said surface hydrolyzable functional groups.

6. The process of claim 3 wherein said steps (ii) and (iii) are carried out contemporaneously.

7. The process of claim 3 wherein said adsorbing step (ii) comprises providing a solution comprising a low concentration of an organic acid dissolved in a solvent and contacting the solution to said substrate surface in an amount sufficient to form a mono-layer film of said organic acid species on at least a portion of said substrate surface.

8. The process of claim 7 further comprising, subsequent to contacting said substrate surface with said solution, removing the remaining solution from contact with said substrate under conditions which leave on at least a portion of said substrate surface said adsorbed, dense, oriented organic mono-layer film, and optionally, either subsequently to or simultaneously with said remaining solution removal, evaporating any residual solvent from said adsorbed mono-layer film.

9. The process of claim 8 wherein said remaining solution removal and said evaporation of residual solvent are contemporaneously carried out by traversing the substrate surface with an acid solution meniscus.

10. The process of claim 9 wherein said acid solution meniscus traversal of the substrate surface is provided by progressively sweeping said substrate surface with a gas stream directed at the interface of said substrate surface and said solution surface.

11. The process of claim 9 wherein said substrate surface is contacted with a solution comprising an organic acid species in a solvent by suspending said substrate in a fixed location immersed in a volume of said solution.

12. The process of claim 11 wherein said substrate surface is traversed with an acid solution meniscus by evaporating a portion of the solvent from said solution.

13. The process of claim 3 wherein said hydrolyzable functional groups are oxide functional groups and said substrate surface comprises the oxide surface of a substrate selected from the group consisting of: (a) materials having a native oxide surface which have electrically conducting, semiconducting, insulating or metallic properties; and (b) a bulk oxide, an oxide conductor, and an oxide insulator.

14. The process of claim 8 wherein said hydrolyzable functional groups are oxide functional groups and said substrate surface comprises the oxide surface of a substrate selected from the group consisting of a native oxide surface of a metal, a native oxide surface of a semiconductor, a native oxide surface of an insulator, and an oxide conductor.

15. The process of claim 8 wherein said substrate is selected from the group consisting of the native surface of a silicon-based semiconductor, the naked surface of a silicon-based semiconductor, the native surface of a germanium-based semiconductor, the naked surface of a germanium-based semiconductor, the native surface of a gallium-arsenide-based semiconductor, the naked surface of a gallium-arsenide-based semiconductor, an indium tin oxide conductor, an aluminium zinc oxide conductor, a titanium oxide conductor, and an iron oxide conductor.

16. The process of claim 3 wherein said organic acid species has an acid functional group selected from the group consisting of a sulfonic acid functional group, a carboxylic acid functional group, and a phosphonic acid functional group.

17. The process of any of claim 8 wherein said organic acid species is selected from the group consisting of mono-, di- and polyfunctional carboxylic acids, and mono-, di- and polyfunctional phosphonic acids.

18. The process of claim 8 wherein said organic acid species comprises at least one acid functional group selected from the group consisting of a carboxylic acid functional group and a phosphonic acid functional group, and attached thereto a hydrocarbon portion selected from the group consisting of a linear, branched or cyclic, saturated or unsaturated, substituted or unsubstituted aliphatic moiety, a substituted or unsubstituted, monomeric, oligomeric, or polymeric aromatic moiety, a substituted or unsubstituted, monomeric, oligomeric, or polymeric heteroaromatic moiety.

19. The process of claim 18 wherein said hydrocarbon portion is selected from the group consisting of, a substituted or unsubstituted thiophene moiety, a substituted or unsubstituted polythiophene moiety, an oligomeric heterocyclic moiety, a polymeric heterocyclic moiety, a linear or branched, saturated or unsaturated, substituted or unsubstituted aliphatic moiety having from about 2 to about 40 carbon atoms, a substituted or unsubstituted aromatic or heteroaromatic moiety, a substituted or unsubstituted linear phenylene, a polymeric aromatic moiety, a TCNQ derivative, and a TTF derivative, and wherein said hydrocarbon moiety is optionally additionally substituted with one or more functional groups selected from the group consisting of a carboxylic acid functional group, a hydroxyl functional group, an amino functional group, a phosphonic acid functional group, an ether functional group, a polyether functional group, and a thiol functional group.

20. The process of claim 8 wherein said organic acid species is an omega substituted di functional carboxylic or phosphonic acid having an omega-substituent selected from the group consisting of hydroxyl, amino, carboxylic acid, phosphonic acid, and thiol functional groups.

21. The process of claim 19 wherein said organic acid species is a phosphonic acid selected from the group consisting of nitrophenylphosphonic acid, benzylphosphonic acid, butylphosphonic acid, octylphosphonic acid, octadecylphosphonic acid, substituted and unsubstituted anthracenephosphonic acids, substituted and unsubstituted pentacenephosphonic acids, substituted and unsubstituted quarterthiophene phosphonic acids, 11-hydroxyundecylphosphonic acid, omega-carboxylic acid phosphonic acids having a hydrocarbon portion comprising from about 2 to about 20 carbon atoms, and substituted and unsubstituted xylyl-phosphonic acid and combinations of two or more thereof.

22. The process of claim 20 wherein said organic acid species is a carboxylic acid selected from the group consisting of alkylcarboxylic acids having from about 2 to about 40 carbon atoms, benzoic acid, substituted benzoic acids, wherein said substituent comprises at least one member selected from the group consisting of hydroxyl, amino, carboxylic acid functional groups, and linear or branched, substituted or unsubstituted alkyl moieties having from about 2 to about 20 carbon atoms which are optionally functionalized with one or more functional groups selected from the group consisting of hydroxyl, amino and carboxylic acid functional groups, salicylic acid, and substituted and unsubstituted alkyl salicylic acids.

23. A densely-packed, organic acid-based mono-layer chemically bonded to the surface of a substrate prepared according to the process of claim 8.

24. A densely-packed, organic acid-based mono-layer chemically bonded to the surface of a substrate prepared according to the process of claim 19.

25. The process of claim 24 further comprising bonding said additional functional groups to an organic or bioactive moiety.

26. A process for providing on a substrate having a surface comprising a plurality of oxide functional groups a dense, oriented, mono-layer based on one or more organic acid species containing at least one acid functional group selected from a phosphonic acid functional group and a carboxylic acid functional group, the method comprising:
(i) providing a solution comprising at least one said organic acid species containing at least one said acid functional group in a solvent wherein said acid species and is present in the solution at a low concentration;
(ii) contacting to at least a portion of the substrate surface to be provided with a mono-layer, said solution from step (i) in an amount and under conditions sufficient to form an adsorbed, dense, oriented mono-layer film comprising the organic acid species, wherein, at the interface between said adsorbed organic acid species and said substrate surface, each said adsorbed organic acid species comprising said mono-layer contains at least one acid functional group associated with at least one oxide functional group of said substrate surface;
(iii) subsequent to solution contacting step (ii), removing from contact with the substrate any remaining solution under conditions which leave on at least a portion of said substrate surface said adsorbed, dense, oriented mono-layer film and optionally residual amounts of said solvent;
(iv) when present, subsequent to or contemporaneous with solution removing step(iii), evaporating substantially all said residual solvent; and
(v) subsequent to or contemporaneous with step (iv), if step (iv) is performed, supplying to the interfacial region comprising said adsorbed mono-layer and said oxide surface sufficient heat energy of sufficient duration to cause at least some of said oxide surface associated acid functional groups to form a chemical bond with said substrate surface oxide functional groups.

27. The process of claim 26 further comprising repeating steps (i) to (v) until said mono-layer covers, substantially without void areas, the entirety of said portion of said oxide surface to be provided with a mono-layer.

28. The process of claim 26 wherein said “heat supplying step” (v) comprises placing said substrate into an environment having a temperature in excess of about 100° C.

29. The process of claim 28 wherein said contacting step (ii) is carried out by dispensing a volume of said organic acid solution onto said substrate surface under conditions permitting at least some of said volume of solution to form a solution layer on the substrate surface.

30. The process of claim 29 wherein said solution removing step (iii) is carried out in accordance with the process of claim 10.

31. The process of claim 28 wherein said contacting step (ii) is carried out by suspending said substrate in a fixed location immersed in a volume of said solution.

32. The process of claim 31 wherein contacting step (ii) and removing step (iii) are carried out in accordance with the process of claim 12.

33. The process of claim 32 wherein said organic acid species is selected from mono-, di-, and polyfunctional phosphonic acids.

34. The process of claim 32 wherein said organic acid species is selected from mono-, di-, and polyfunctional carboxylic acids.

35. The dense, oriented, mono-layer film provided by the process of claim 32.

36. The process of claim 32 wherein said organic acid species is an omega hydroxyalkylphosphonic acid.

37. The dense, oriented, mono-layer film prepared by the process of claim 36.
